(19) United States
(12) Patent Application Publication
(10) Pub. No.: US 2022/0319788 A1
(43) Pub. Date: Oct. 6, 2022

(54) CHIP-TYPE CURRENT FUSE

(71) Applicant: KOA CORPORATION, Nagano (JP)

(72) Inventors: Hiroshi ICHIKAWA, Nagano (JP); Tomonori OGUCHI, Nagano (JP); Atsushi KARASAWA, Nagano (JP)

(73) Assignee: KOA CORPORATION, Nagano (JP)

(21) Appl. No.: 17/638,752

(22) PCT Filed: May 21, 2020
(86) PCT No.: PCT/JP2020/020089

§ 371 Date: Mar. 7, 2022

(30) Foreign Application Priority Data
Aug. 27, 2019 (JP) 2019-155013

(51) Int. Cl. H01H 37/76

(52) U.S. Cl. CPC H01H 37/761

(57) ABSTRACT

The chip-type current fuse is configured to include a fuse element 5 formed between a first front electrode 3 and a second front electrode 4. The fuse element 5 includes: a first linear portion 5a that has an end connected to the first front electrode 3 and extends in a direction toward the second front electrode 4; a second linear portion 5b that has an end connected to the second front electrode 4 and extends in parallel to the first linear portion 5a in a direction toward the first front electrode 3; and an inclined linear portion 5c that links the first linear portion 5a and the second linear portion 5b to each other. The inclined linear portion 5c is connected at an acute angle to each of the first linear portion 5a and the second linear portion 5b.

### TECHNICAL FIELD

The present invention relates to a surface mounting chip-type current fuse.

### BACKGROUND ART

A chip-type current fuse mainly includes: an insulating substrate of a rectangular solid shape; a pair of front electrodes that are respectively formed on both longitudinal end portions of the front surface of the insulating substrate; a fuse element that is formed between the pair of front electrodes; a protective layer that covers the fuse element; a pair of back electrodes that are formed on both longitudinal end portions of the back face of the insulating substrate; a pair of end electrodes that are formed on both longitudinal end faces of the insulating substrate and each provides connection between the corresponding front electrode and the corresponding back electrode; and the like.

In the chip-type current fuse configured in this way, if a predetermined overcurrent flows between a pair of front electrodes, the current is concentrated on the fuse element, so that heat is produced. In turn, the fuse element is melted by the produced heat to thereby protect various types of electronic equipment connected to the chip-type current fuse.

Where the fuse element is formed between the pair of front electrodes in a linear fashion, a shorter distance between the front electrodes with reduction in size of the chip-type current fuse causes a reduced thermal capacity of the fuse element, which in turn results in a decrease in pulse resistance. To avoid this, conventionally, chip-type current fuses with pulse resistance increased by forming a fuse element in a folded shape are suggested as described in Patent Literature 1.

FIG. 6 is a plan view of the chip-type current fuse described above in Patent Literature 1, in which the chip-type current fuse 100 includes a first front electrode 102 and a second front electrode 103 that are formed on both longitudinal end portions of an insulating substrate 101 of a rectangular solid shape, as well as a fuse element 104 that is formed between the first front electrode 102 and the second front electrode 103. The fuse element 104 is made up of: a linear portion 104a horizontally extending from an upper portion of the first front electrode 102 to the vicinity of an upper portion of the second front electrode 103; a linear portion 104b extending at a right angle from the leading end of the linear portion 104a; a linear portion 104c extending in parallel to the linear portion 104a from the leading end of the linear portion 104b to the vicinity of a central portion of the first front electrode 102; a linear portion 104d extending at a right angle from the leading end of the linear portion 104c; and a linear portion 104e extending in parallel to the linear portion 104a from the leading end of the linear portion 104d to the vicinity of a lower portion of the second front electrode 103, so that the fuse element 104 is formed in a shape such as being folded into a plurality of straight lines.

Because the chip-type current fuse 100 configured as described above has the fuse element 104 of a folded shape, the full length of the fuse element 104 is longer than that of a fuse element formed in a linear fashion. As a result, the thermal capacity of the fuse element 104 is increased to improve pulse resistance.

### CITATION LIST

### Patent Literature

Patent Literature 1: Japanese Published Unexamined Patent Application No. Hei 11-96885

### SUMMARY OF INVENTION

### Technical Problem

In the chip-type current fuse described in Patent Literature 1, the linear portion 104a connecting continuously to the first front electrode 102 and the linear portion 104e connecting continuously to the second front electrode 103 are locations that allow heat to escape readily (thermal dissipation portion). Therefore, the heat produced in the fuse element 104 is concentrated on the linear portion 104b, the linear portion 104c, and the linear portion 104d which are formed between the linear portions 104a, 104e. Thus, when a predetermined overcurrent flows between the first front electrode 102 and the second front electrode 103, melting occurs in any location of the linear portions 104b, 104c, 104d. However, because it is not determined which location(s) of the linear portions 104b, 104c, and 104d melts with the linear portions 104b, 104c, and 104d linked together in a crank shape, there is a problem of unstable timing when melting occurs.

The present invention has been made in view of such circumstances in the conventional art and it is an object thereof to provide a chip-type current fuse capable of stabilizing timing when a fuse element melts.

### Solution to Problem

To achieve the object, an aspect of the present invention provides a chip-type current fuse that includes: an insulating substrate of a rectangular solid shape; a first front electrode and a second front electrode that are formed on both longitudinal end portions of a front face of the insulating substrate; a first back electrode and a second back electrode that are formed on both longitudinal end portions of a back face of the insulating substrate; a first end electrode that is formed on one of longitudinal end faces of the insulating substrate to connect the first front electrode and the first back electrode to each other; a second end electrode that is formed on the other longitudinal end face of the insulating substrate to connect the second front electrode and the second back electrode to each other; and a fuse element that is formed between the first front electrode and the second front electrode. The fuse element includes: a first linear portion that has an end connected to the first front electrode and extends in a direction toward the second front electrode; a second linear portion that has an end connected to the second front electrode and extends in parallel to the first linear portion in a direction toward the first front electrode; and an inclined linear portion that links the first linear portion and the second linear portion to each other. The inclined linear portion is connected at an acute angle to each of the first linear portion and the second linear portion.

In the chip-type current fuse configured as described above, the first linear portion connected to the first front electrode and the second linear portion connected to the second front electrode serve as locations that allows heat to escape readily, and the inclined linear portion formed between the first linear portion and the second linear portion is connected at an acute angle to each of the both linear portions. As a result, the heat produced in the fuse element is concentrated on the vicinity of the center of the inclined linear portion, so that the vicinity of the center of the inclined linear portion can be melted at stable timing.

In the chip-type current fuse of the above configuration, the fuse element has a point symmetric shape which is symmetric about a point at the center of the inclined linear portion, specifically, a Z shape in planar view with both ends of the inclined linear portion connecting continuously to the first linear portion and the second linear portion, respectively. Because of this, melting stably will occur in the vicinity of the center of the inclined linear portion.

Further, in the chip-type current fuse of the above configuration, the distance from the center of the inclined linear portion to the first back electrode and the second back electrode is set to be longer than the distance from the center of the inclined linear portion to the first front electrode and the second front electrode. Because of this, the heat produced in the fuse element is hard to be dissipated from the first back electrode and the second back electrode located on the underside of the insulating substrate. Therefore, the vicinity of the center of the inclined linear portion can be melted stably.

Further, the chip-type current fuse of the above configuration, when an area between the first front electrode and the second front electrode is defined as an element formation region, the first back electrode and the second back electrode are formed on the outside of a back face region on which the element formation region is projected. Thus, the vicinity of the center of the inclined linear portion can be melted stably.

### Advantageous Effects of Invention

In the chip-type current fuse according to the present invention, the inclined linear portion formed between the first linear portion and the second linear portion is connected at an acute angle to each of the linear portions. This enables stabilization of timing when the fuse element melts.

### BRIEF DESCRIPTION OF DRAWINGS

FIG. 1 is a plan view of a chip-type current fuse according to example embodiments of the present invention.

FIG. 2 is a sectional view taken along line II-II of FIG. 1.

FIG. 3 is an explanatory diagram of a fuse element included in the chip-type current fuse.

Each FIG. 4A to FIG. 4F show plan view illustrating the process of manufacturing the chip-type current fuse.

Each FIG. 5A to FIG. 5F show sectional view illustrating the process of manufacturing the chip-type current fuse.

FIG. 6 is a plan view of a chip-type current fuse according to conventional examples.

### DESCRIPTION OF EMBODIMENT

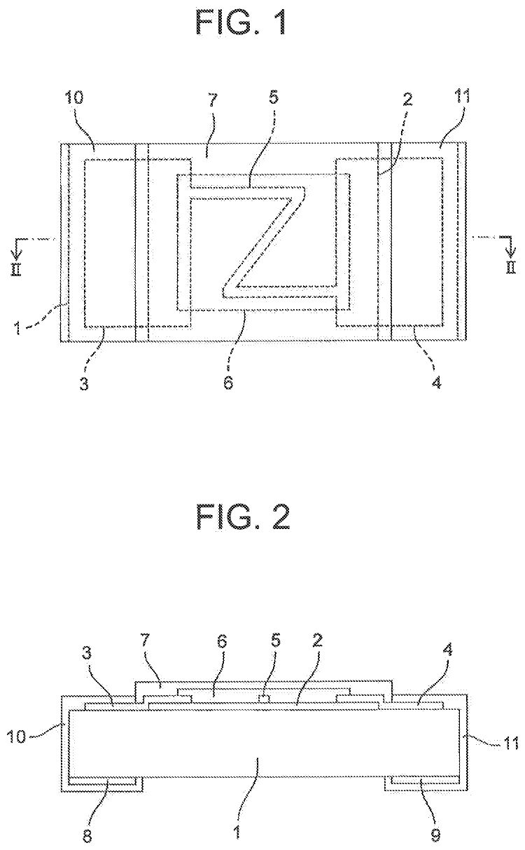

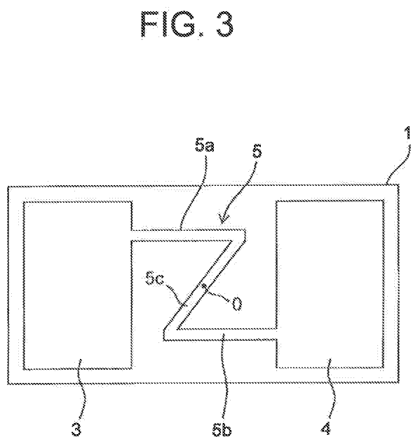

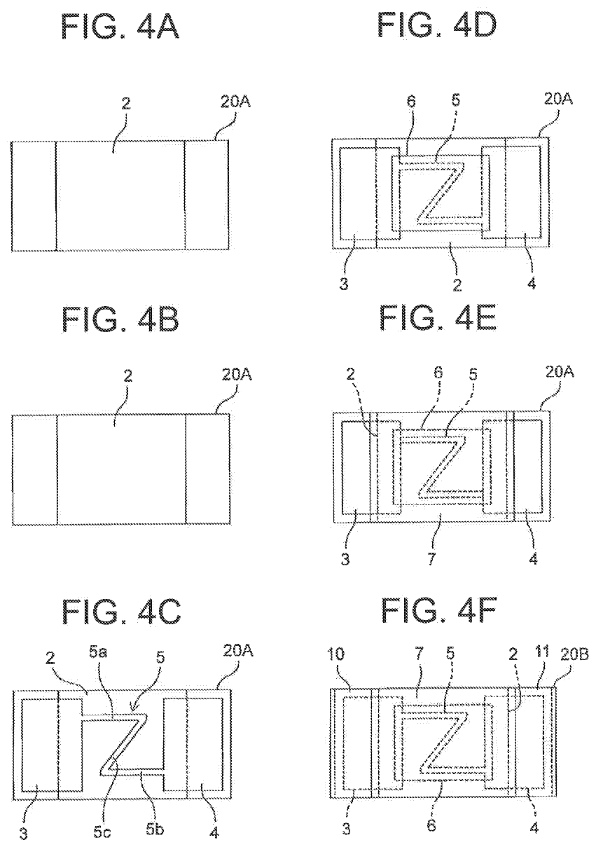

Embodiments according to the invention will now be described with reference to the accompanying drawings. FIG. 1 is a plan view of a chip-type current fuse according to example embodiments of the present invention. FIG. 2 is a sectional view taken along line II-II of FIG. 1.

As illustrated in FIGS. 1 and 2, the chip-type current fuse according to the example embodiments mainly includes: an insulating substrate 1 of a rectangular solid shape; a thermal storage layer 2 that is formed on a region of the front face of the insulating substrate 1 other than both longitudinal end portions thereof; a first front electrode 3 and a second front electrode 4 that are formed on the both longitudinal end portions of the front face of the insulating substrate 1 to overlap partially the thermal storage layer 2; a fuse element 5 that is formed on the thermal storage layer 2 to provide continuity between the first front electrode 3 and the second front electrode 4; an inner protective layer 6 that covers the fuse element 5; a protective layer 7 that covers parts of the first front electrode 3 and the second front electrodes 4 and the entire inner protective layer 6; a first back electrode 8 and a second back electrode 9 that are formed on both longitudinal end portions of the back face of the insulating substrate 1; a first end electrode 10 that is formed on one of longitudinal end faces of the insulating substrate 1 to connect the first front electrode 3 and the first back electrode 8 to each other; and a second end electrode 11 that is formed on the other longitudinal end face of the insulating substrate 1 to connect the second front electrode 4 and the second back electrode 9 to each other.

The insulating substrate 1 is one of multiple insulating substrates obtained by dividing a large substrate, which will be described later, along crisscross division grooves. The large substrate is a ceramic substrate made primarily of alumina.

The thermal storage layer 2 is made by coating (e.g., screen printing) and firing of glass paste or by coating (e.g., spin coat) and curing of resin such as polyimide resin and/or the like, and is formed in a rectangular shape to cover a central portion of the front face of the insulating substrate 1.

For the first front electrode 3, the second front electrode 4 and the fuse element 5, a metal thin film (e.g., Cu, Ag, Au, Al and/or the like) which is meltable as a fuse is sputtered or evaporated onto the entire front face of the insulating substrate 1, and the resultant is patterned using photolithography. The first front electrode 3 and the second front electrode 4 are formed in a rectangular shape on the both longitudinal end portions of the insulating substrate 1, and the fuse element 5 is formed in a Z shape in planar view, between the first front electrode 3 and the second front electrode 4. Incidentally, the detailed configuration of the fuse element 5 will described later.

The inner protective layer 6 is made by drying and firing a coating (e.g., screen printing) of inner protective materials (e.g., glass paste, silicone resin and/or the like), and is formed in a rectangular shape to cover parts of the first front electrode 3 and the second front electrode 4 and the entire fuse element 5.

The protective layer 7 is made by heating and curing a coating (e.g., screen printing) of epoxy-based resin paste, and is formed in a rectangular shape to cover parts of the first front electrode 3 and the second front electrode 4 and the entire inner protective layer 6.

The first back electrode 8 and the second back electrode 9 are made by drying and firing a coating (e.g., screen printing) of Ag based paste made primarily of silver, and are formed in a rectangular shape on both longitudinal end portions of the back face of the insulating substrate 1. The first front electrode 3 and the first back electrode 8 are formed in positions corresponding to each other, and the second front electrode 4 and the second back electrode 9 are also formed in positions corresponding to each other. The first back electrode 8 and the second back electrode 9 are formed to be smaller in area than the first front electrode 3 and the second front electrode 4. Therefore, when an element formation region is defined between the first front electrode 3 and the second front electrode 4 which are formed on the front face of the insulating substrate 1, the first back electrode 8 and the second back electrode 9 are placed on the outside of a back face region on which the element formation region is projected.

The first end electrode 10 and the second end electrode 11 are made by sputtering or evaporating end electrode materials (e.g., a Ni/Cr2 layer, a NiCr alloy, a Ni/Ti2 layer, a NiTi alloy) onto both longitudinal end faces of the insulating substrate 1. The first end electrode 10 and the second end electrode 11 are correspondingly formed to provide continuity between the first front electrode 3 and the first back electrode 8 and to provide continuity between the second front electrode 4 and the second back electrode 9. Although not shown, the surfaces of the first end electrode 10 and the second end electrode 11 are covered with external electrodes which have double-layer structure formed of a Ni plated layer and a Sn plated layer.

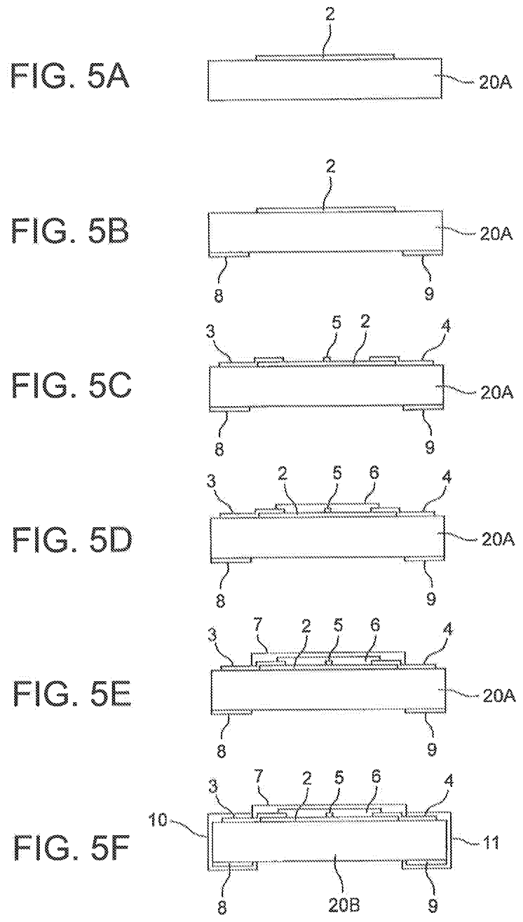

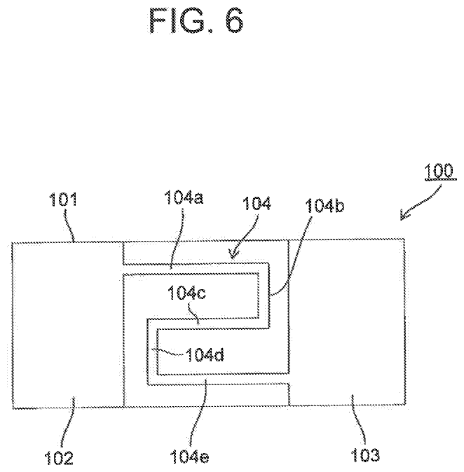

FIG. 3 is an explanatory diagram of the fuse element 5 described earlier. As illustrated in FIG. 3, the fuse element 5 is made up of a first linear portion 5a, a second linear portion 5b, and an inclined linear portion 5c. The first linear portion 5a has an end connected to an upper portion of the first front electrode 3 in FIG. 3, and extends in parallel to the longitudinal direction of the insulating substrate 1 in a direction toward the second front electrode 4. The second linear portion 5b has an end connected to a lower portion of the second front electrode 4 in FIG. 3, and extends in parallel to the first linear portion 5a in a direction toward the first front electrode 3. The inclined linear portion 5c links the first linear portion 5a and the second linear portion 5b to each other. The inclined linear portion 5c is connected at an acute angle to each of the first linear portion 5a and the second linear portion 5b. Here, the first linear portion 5a and the second linear portion 5b are set to be identical in horizontal length, and the fuse element 5 has a point symmetric shape which is symmetric about a point at the center O of the inclined linear portion 5c, specifically, in a Z shape in planar view.

A process of manufacturing the chip-type current fuse according to the example embodiment will be described below with reference to FIGS. 4 and 5. FIGS. 4A to 4F are superficial plan views of a large substrate used in the manufacturing process. FIGS. 5A to 5F respectively show sectional views of an equivalent of a chip taken along the longitudinal central portion in FIGS. 4A to 4F.

Initially, a large substrate from which multiple insulating substrates 1 are obtained is prepared. Primary division grooves and secondary division grooves are previously formed in a grid shape in the large substrate, and each of individual squares defined by the primary and secondary division grooves results in a single chip region. Although a large substrate 20A corresponding to a single chip region is illustrated as a representative in FIGS. 4 and 5, in actuality, each of process steps as described below is collectively performed on the large substrate corresponding to a large number of chip regions.

Specifically, after the front face of the large substrate 20A is coated (e.g., screen printed) with glass paste, the resultant is dried and fired to thereby form the thermal storage layer 2 of a rectangular shape in a central portion of the front face of the large substrate 20A as illustrated in FIG. 4A and FIG. 5A.

Then, after the back face of the large substrate 20A is coated (e.g., screen printed) with Ag based paste, the resultant is dried and fired to thereby form the first back electrodes 8 and the second back electrodes 9 on the opposite sides of a predetermined space from each other on the back face of the large substrate 20A as illustrated in FIG. 4B and FIG. 5B.

Then, a metal thin film such as of Cu, Ag and/or the like is deposited on the entire front face of the large substrate 20A by sputtering (or evaporating), which is then patterned using photolithography to thereby form integrally the first front electrodes 3 and the second front electrodes 4 on the opposite sides of a predetermined space from each other, as well as the fuse elements 5 each running between the first front electrode 3 and the second front electrode 4, as illustrated in FIG. 4C and FIG. 5C. Each fuse element 5 is formed in a Z shape in planar view on the thermal storage layer 2, and has: the first linear portion 5a that has an end connected to the first front electrode 3 and extends in parallel to the longitudinal direction of the insulating substrate 1 in a direction toward the second front electrode 4; the second linear portion 5b that has an end connected to the second front electrode 4 and extends in a direction toward the first front electrode 3; and the inclined linear portion 5c that links the first linear portion 5a and the second linear portion 5b to each other. The inclined linear portion 5c is connected at an acute angle to each of the first linear portion 5a and the second linear portion 5b. The shortest distance from the center of the inclined linear portion 5c to the back front electrode 8 and the second back electrode 9 is set to be longer than the shortest distance from the center of the inclined linear portion 5c to the first front electrode 3 and the second front electrode 4.

Then, after the front face of the large substrate 20A is screen printed with glass paste, the resultant is dried and fired to thereby form the inner protective layers 6 so that each inner protective layer 6 covers parts of the first front electrode 3 and the second front electrode 4 and the entire fuse element 5, as illustrated in FIG. 4D and FIG. 5D. In this way, the fuse element 5 is sandwiched between the thermal storage layer 2 and the inner protective layer 6.

Then, after the front face of the large substrate 20A is coated (e.g., screen printed) with epoxy-based resin paste, the resultant is heated and cured, to thereby form the protective layers 7 so that each protective layer 7 covers parts of the first front electrode 3 and the second front electrode 4 and the entire inner protective layer 6, as illustrated in FIG. 4E and FIG. 5E.

Then, after the large substrate 20A is primarily divided along the primary division grooves into strip-shaped substrates 20B, end electrode materials are sputtered or evaporated (e.g., a Ni/Cr2 layer, a NiCr alloy, a Ni/Ti2 layer, a NiTi alloy) onto divided faces of each strip-shaped substrate 20B to thereby form the first end electrodes 10 and the second end electrodes 11 on both ends of the strip-shaped substrate 20B, as illustrated in FIG. 4F and FIG. 5F. Each first end electrode 10 provides continuity between the corresponding first front electrode 3 and the corresponding first back electrode 8 and each second end electrode 11 provides continuity between the corresponding second front electrode 4 and the corresponding second back electrode 9.

And then, after the strip-shaped substrate 20B is secondarily divided along the secondary division grooves into multiple chip substrates, electrolytic plating is added to each chip substrate to form a layer of Ni—Sn plating. Thereby, an external electrode (not shown) is formed to cover each of the surfaces of the first end electrode 10 and the second end electrode 11. In this manner, the chip-type current fuse illustrated in FIGS. 1, 2 is completed.

As described above, the chip-type current fuse according to the example embodiment is configured to include the fuse element 5 formed between the first front electrode 3 and the second front electrode 4, the fuse element 5 including: the first linear portion 5a that has an end connected to the first front electrode 3 and extends in parallel to the longitudinal direction of the insulating substrate 1 in a direction toward the second front electrode 4; the second linear portion 5b that has an end connected to the second front electrode 4 and extends in parallel to the first linear portion 5a in a direction toward the first front electrode 3; and the incline linear portion 5c that links the first linear portion 5a and the second linear portion 5b to each other, and the inclined linear portion 5c is connected at an acute angle to each of the first linear portion 5a and the second linear portion 5b. Therefore, the first linear portion 5a connected to the first front electrode 3 and the second linear portion 5b connected to the second front electrode 4 serve as locations that allows heat to escape readily (thermal dissipation portion), and the inclined linear portion 5c formed between the first linear portion 5a and the second linear portion 5b is connected at an acute angle to each of the linear portions 5a, 5b. As a result, the heat produced in the fuse element 5 is concentrated on the vicinity of the center of the inclined linear portion 5c, so that the vicinity of the center of the inclined linear portion 5c can be melted at stable timing.

Also, in the chip-type current fuse according to the example embodiment, because the fuse element 5 has a point symmetric shape which is symmetric about a point at the center O of the inclined linear portion 5c (a Z shape in planar view), melting will stably occur in the vicinity of the center of the inclined linear portion 5c. Furthermore, the shortest distance from the center of the inclined linear portion 5c to the back front electrode 8 and the second back electrode 9 is set to be longer than the shortest distance from the center of the inclined linear portion 5c to the first front electrode 3 and the second front electrode 4. Because of this, the heat produced in the fuse element 5 is hard to be dissipated from the first and second back electrodes 8, 9 located on the underside of the insulating substrate 1, and therefore the vicinity of the center of the inclined linear portion 5c can be melted stably. Further, if an element formation region is defined between the first front electrode 3 and the second front electrode 4 which are formed on the front face of the insulating substrate 1, the first back electrode 8 and the second back electrode 9 are placed on the outside of a back face region on which the element formation region is projected. In this respect, the vicinity of the center of the inclined linear portion 5c can also be melted stably.

It should be understood that although the first linear portion 5a, the second linear portion 5b, and the inclined linear portion 5c of the fuse element 5 are approximately equal in length to each other in the above example embodiment, the relative length of each linear portion 5a, 5b, 5c is not limited to the above example embodiment and, for example, the length of the inclined linear portion 5c may be sufficiently shorter than the first linear portion 5a and the second linear portion 5b.

### LIST OF REFERENCE SIGNS

1 Insulating substrate
2 Thermal storage layer
3 First front electrode
4 Second front electrode
5 Fuse element
5a First linear portion
5b Second linear portion
5c Inclined linear portion
6 Inner protective layer
7 Protective layer
8 First back electrode
9 Second back electrode
10 First end electrode
11 Second end electrode

1. A chip-type current fuse, comprising:
an insulating substrate of a rectangular solid shape;
a first front electrode and a second front electrode that are formed on both longitudinal end portions of a front face of the insulating substrate;
a first back electrode and a second back electrode that are formed on both longitudinal end portions of a back face of the insulating substrate;
a first end electrode that is formed on one of longitudinal end faces of the insulating substrate to connect the first front electrode and the first back electrode to each other;
a second end electrode that is formed on the other longitudinal end face of the insulating substrate to connect the second front electrode and the second back electrode to each other; and
a fuse element that is formed between the first front electrode and the second front electrode,
wherein the fuse element includes
a first linear portion that has an end connected to the first front electrode and extends in a direction toward the second front electrode,
a second linear portion that has an end connected to the second front electrode and extends in parallel to the first linear portion in a direction toward the first front electrode, and
an inclined linear portion that links the first linear portion and the second linear portion to each other, and
the inclined linear portion is connected at an acute angle to each of the first linear portion and the second linear portion.

2. The chip-type current fuse according to claim 1,
wherein the fuse element has a point symmetric shape which is symmetric about a point at a center of the inclined linear portion.

3. The chip-type current fuse according to claim 1 or 2,
wherein a distance from the center of the inclined linear portion to the first back electrode and the second back electrode is set to be longer than a distance from the center of the inclined linear portion to the first front electrode and the second front electrode.

4. The chip-type current fuse according to claim 1,
wherein when an area between the first front electrode and the second front electrode is defined as an element formation region, the first back electrode and the second back electrode are formed on the outside of a back face region on which the element formation region is projected.
